(19) United States
(12) Patent Application Publication
(10) Pub. No.: US 2014/0013419 A1
(43) Pub. Date: Jan. 9, 2014

(54) ELECTRONIC DEVICE FOR MULTIPLE USERS AND LOGIN METHOD THEREOF

(71) Applicant: Rachel Chen, New Taipei City (TW)

(72) Inventor: Rachel Chen, New Taipei City (TW)

(21) Appl. No.: 13/609,276

(22) Filed: Sep. 11, 2012

(30) Foreign Application Priority Data
Jul. 3, 2012 (CN) 201210229216.6

(51) Int. Cl. G06F 21/00

(52) U.S. Cl. 726/17

(57) ABSTRACT

An electronic device for multiple users includes a storage module for storing N user accounts, N being a positive integer larger than one; a touch display module; and a processing module electrically connected to the storage module and the touch display module, the processing module being used for displaying a login interface in the touch display module, the login interface including N slide paths, each of the N slide paths being corresponding to one of the N user accounts; wherein after performing a slide gesture on an i-th slide path of the N slide paths, the processing module logins the electronic device by an i-th user account of the N user accounts, which is corresponding to the i-th slide path, i is a positive integer smaller than or equal to N.

### BACKGROUND OF THE INVENTION

1. Field of the Invention

The invention relates to an electronic device for multiple users and a login method thereof and, more particularly, to a login method using different slide paths to login an electronic device by different users.

2. Description of the Prior Art

As technology developed and advanced, various electronic devices, such as flat computer, smart phone, personal digital assistant (PDA) and so on, are considered necessities by a lot of people. So far there is only one user account set in each of the aforesaid electronic devices including flat computer, smart phone, PDA and so on. In other words, all users share the same user account to use those electronic devices and any operations are performed under the same user account, such as fly mode setting, wireless communication, make/answer phone calls, send/read messages, install/uninstall applications/software and soon. Accordingly, the setting may be changed casually or the data may be stolen by someone.

### SUMMARY OF THE INVENTION

The invention provides an electronic device for multiple users and a login method thereof so as to solve the aforesaid problems.

According to the claimed invention, an electronic device for multiple users comprises a storage module for storing N user accounts, N being a positive integer larger than one; a touch display module; and a processing module electrically connected to the storage module and the touch display module, the processing module being used for displaying a login interface in the touch display module, the login interface comprising N slide paths, each of the N slide paths being corresponding to one of the N user accounts; wherein after performing a slide gesture on an i-th slide path of the N slide paths, the processing module logins the electronic device by an i-th user account of the N user accounts, which is corresponding to the i-th slide path, i is a positive integer smaller than or equal to N.

According to the claimed invention, the storage module further stores N passwords, each of the N passwords is corresponding to one of the N user accounts, after performing the slide gesture on the i-th slide path, the processing module displays a password blank, after filling in the password blank with an i-th password of the N passwords, which is corresponding to the i-th user account, the processing module logins the electronic device by the i-th user account.

According to the claimed invention, the storage module further stores N authorities and each of the N authorities is corresponding to one of the N user accounts.

According to the claimed invention, a start point and an end point are defined on each of the N slide paths and the slide gesture is performed to slide from the start point to the end point of the i-th slide path.

According to the claimed invention, the login interface further comprises a slide block for performing the slide gesture.

According to the claimed invention, the processing module displays the N user accounts on the N slide paths correspondingly.

According to the claimed invention, the processing module displays a slide direction on each of the N slide paths.

According to the claimed invention, a login method for multiple users comprises steps of setting N user accounts in an electronic device, wherein the electronic device comprises a touch display module and N is a positive integer larger than one; displaying a login interface in the touch display module, wherein the login interface comprises N slide paths and each of the N slide paths is corresponding to one of the N user accounts; and performing a slide gesture on an i-th slide path of the N slide paths so as to login the electronic device by an i-th user account of the N user accounts, which is corresponding to the i-th slide path, wherein i is a positive integer smaller than or equal to N.

According to the claimed invention, the login method for multiple users further comprises steps of setting N passwords in the electronic device, wherein each of the N passwords is corresponding to one of the N user accounts; after performing the slide gesture on the i-th slide path, displaying a password blank in the touch display module; and after filling in the password blank with an i-th password of the N passwords, which is corresponding to the i-th user account, logining the electronic device by the i-th user account.

According to the claimed invention, the login method for multiple users further comprises step of setting N authorities in the electronic device, wherein each of the N authorities is corresponding to one of the N user accounts.

According to the claimed invention, a start point and an end point are defined on each of the N slide paths and the slide gesture is performed to slide from the start point to the end point of the i-th slide path.

According to the claimed invention, the login interface further comprises a slide block for performing the slide gesture.

According to the claimed invention, the login method for multiple users further comprises step of displaying the N user accounts on the N slide paths correspondingly.

According to the claimed invention, the login method for multiple users further comprises step of displaying a slide direction on each of the N slide paths.

As mentioned in the above, the invention allows an administrator to set a plurality of user accounts in the electronic device and displays a plurality of slide paths, which is corresponding to the plurality of user accounts, in the login interface. The administrator of the electronic device can set different authorities for the plurality of user accounts based on different usage requirements. After a user performs the slide gesture on one of the slide paths, he or she can login the electronic device by corresponding user account and can only use specific functions under the authority of the user account. Furthermore, the invention can further allow the administrator to set a plurality of passwords, which is corresponding to the plurality of user accounts, in the electronic device. After the user performs the slide gesture on one of the slide paths, he or she has to enter corresponding password so as to login the electronic device by corresponding user account. Accordingly, the invention can prevent the setting from being changed or prevent the data from being stolen by someone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating an electronic device for multiple users according to an embodiment of the invention.

FIG. 2 is a schematic diagram illustrating a login interface displayed in a touch display module of the electronic device shown in FIG. 1, wherein a slide block is located at a start point.

FIG. 3 is a schematic diagram illustrating the touch display module and the login interface shown in FIG. 2 being represented by a rectangular coordinate system.

FIG. 4 is a schematic diagram illustrating the slide block shown in FIG. 2 sliding from the start point to an end point of the first slide path.

FIG. 5 is a schematic diagram illustrating another login interface displayed in the touch display module of the electronic device shown in FIG. 1.

FIG. 6 is a flowchart illustrating a login method for multiple users according to an embodiment of the invention.

### DETAILED DESCRIPTION

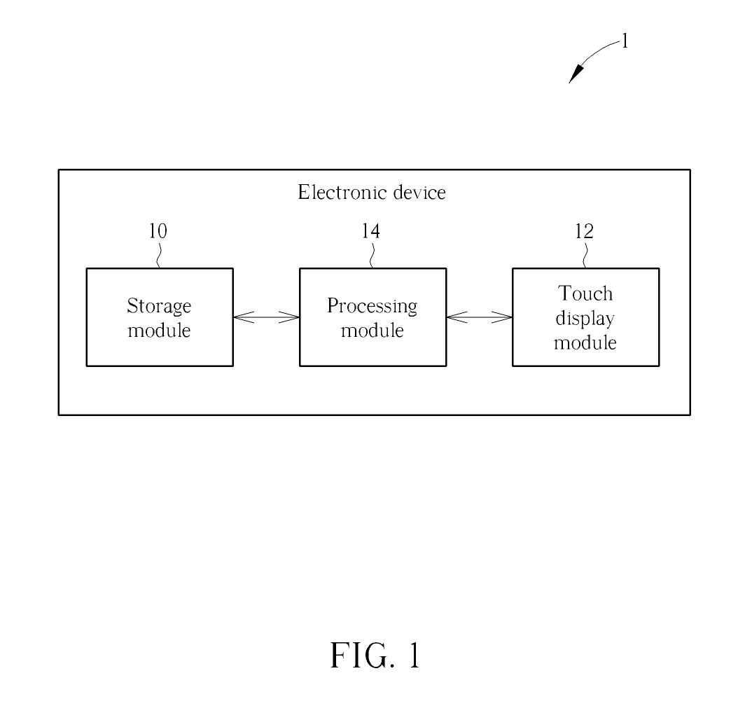

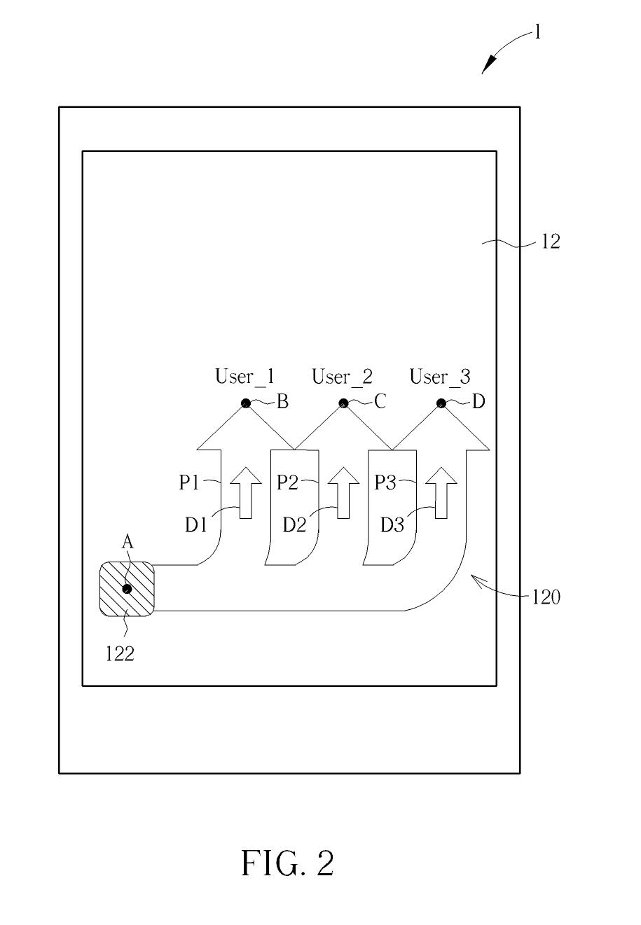

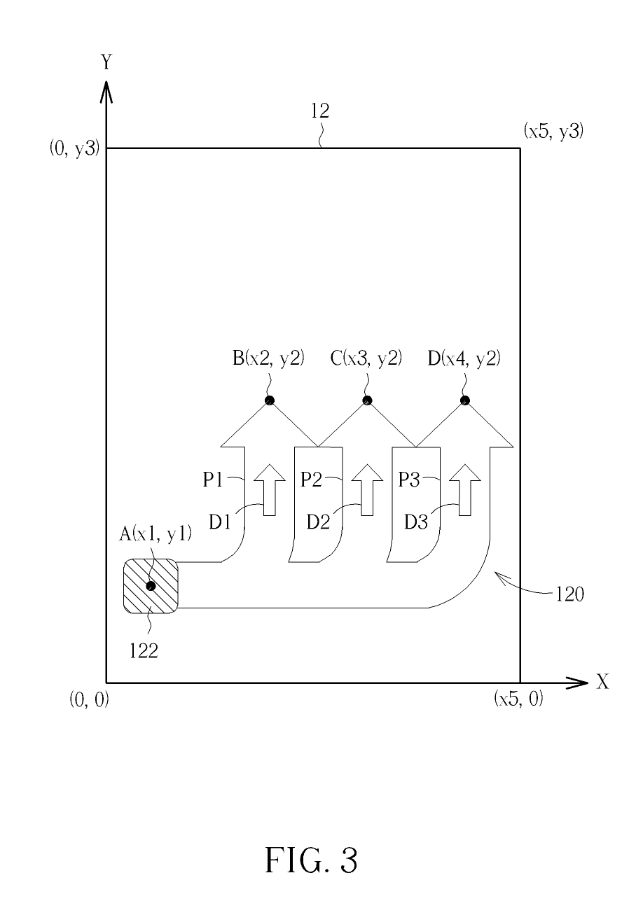

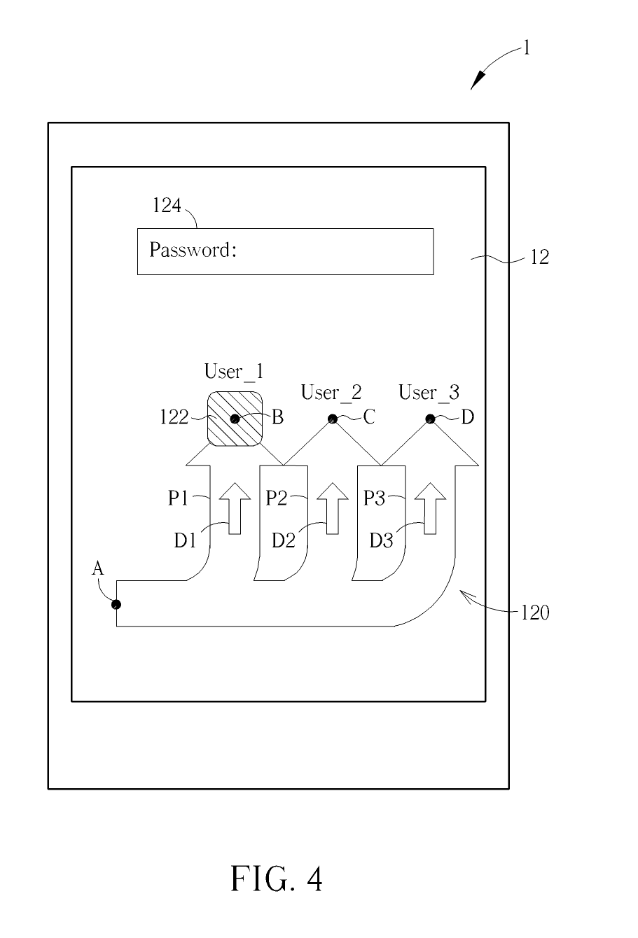

Referring to FIGS. 1 to 4, FIG. 1 is a functional block diagram illustrating an electronic device 1 for multiple users according to an embodiment of the invention; FIG. 2 is a schematic diagram illustrating a login interface 120 displayed in a touch display module 12 of the electronic device 1 shown in FIG. 1, wherein a slide block 122 is located at a start point A; FIG. 3 is a schematic diagram illustrating the touch display module 12 and the login interface 120 shown in FIG. 2 being represented by a rectangular coordinate system; and FIG. 4 is a schematic diagram illustrating the slide block 122 shown in FIG. 2 sliding from the start point A to an end point B of the first slide path P1.

As shown in FIG. 1, the electronic device 1 comprises a storage module 10, a touch display module 12 and a processing module 14, wherein the processing module 14 is electrically connected to the storage module 10 and the touch display module 12. In this embodiment, the electronic device 1 may be a flat computer, smart phone, PDA or other electronic devices with touch display function; the storage module 10 may be a memory or other data storage devices; the touch display module 12 may essentially consist of a touch panel (e.g. resistance-type touch panel, capacitance-type touch panel, etc.) and a display panel (e.g. liquid crystal display panel). In general, the electronic device 1 may be further equipped with some necessary hardware or software components for specific purposes, such as a power supply, an operating system, a wireless communication module, an antenna, a speaker, etc., and it depends on practical applications.

In this embodiment, the storage module 10 is used for storing N user accounts, N passwords and N authorities, wherein N is a positive integer larger than one. As shown in table 1 as follows, the storage module 10 stores three user accounts, three passwords and three authorities (i.e. N=3), wherein each of the passwords and each of the authorities are corresponding to one of the user accounts. For example, Authority_1 of User_1 may be set to allow a user to use some ordinary applications, games, music, alarm clock and so on but forbid the user to send/read messages, make/answer phone calls, use internet, install/uninstall applications/software and so on; Authority_2 of User_2 may be set to allow a user to use some ordinary applications, games, music, alarm clock, send/read messages, make/answer phone calls, use internet and so on but forbid the user to install/uninstall applications/software and so on; Authority_3 of User_3 may be set to allow a user to use any functions of the electronic device 1 including to install/uninstall applications/software. In practical applications, the table 1 may be established as a database stored in the storage module 10. Furthermore, the user accounts, the passwords and the authorities in the table 1 can be added, cancelled or revised by an administrator of the electronic device 1 and the number is not limited to three.

TABLE 1

| User account | Password | Authority |
|---|---|---|
| User_1 | Password_1 | Authority_l |
| User_2 | Password_2 | Authority_2 |
| User_3 | Password_3 | Authority_3 |

When a user wants to use the electronic device 1, the processing module 14 displays a login interface 120 (as shown in FIG. 2) in the touch display module 12, wherein the login interface 120 comprises three slide paths P1, P2, P3 and each of the slide paths P1, P2, P3 is corresponding to one of the three user accounts User_1, User_2, User_3. In this embodiment, the processing module 14 displays the three user accounts User_1, User_{—2, User}_3 on the three slide paths P1, P2, P3 correspondingly, as shown in FIG. 2. Furthermore, the user can use the slide block 122 to perform a slide gesture on any one of the slide paths P1, P2, P3. Moreover, the processing module 14 may display slide directions D1, D2, D3 on each of the slide paths P1, P2, P3.

In this embodiment, a start point and an end point may be defined on each of the slide paths P1, P2, P3. As shown in FIG. 3, if the touch display module 12 and the login interface 120 are represented as a rectangular coordinate system, the coordinates of four corners of the touch display module 12 are represented as (0, 0), (x5, 0), (0, y3), (x5, y3), the coordinate (x1, y1) of point A is the start point shared by the slide paths P1, P2, P3, the coordinate (x2, y2) of point B is the end point of the slide path P1, the coordinate (x3, y2) of point C is the end point of the slide path P2, and the coordinate (x4, y2) of point D is the end point of the slide path P3. It should be noted that the information of the slide paths P1, P2, P3 can be stored in the storage module 10 together with the aforesaid table 1 in a form of database. The invention can determine that the user performs a slide gesture on which slide path through the aforesaid coordinate settings.

When the touch display module 12 displays the login interface 120 shown in FIG. 2, the electronic device 1 is locked. At this time, the user has to perform a slide gesture on an i-th slide path of the three slide paths P1, P2, P3 so as to login the electronic device 1 by an i-th user account of the three user accounts, which is corresponding to the i-th slide path. For example, if the user wants to login the electronic device 1 by the user account User_1, he or she has to operate the slide block 122 to perform a slide gesture by finger, stylus or other touch objects in the slide direction D1 from the start point A to the end point B of the first slide path P1, as shown in FIG. 4. After performing the slide gesture on the first slide path P1, the processing module 14 displays a password blank 124 in the touch display module 12. At this time, the user has to enter the password Password_1, which is corresponding to the user account User_1, into the password blank 124. After filling in the password blank 124 with the password Password_1 corresponding to the user account User_1, the processing module 14 logins and unlocks the electronic device 1 by the user account User_1. At this time, the user can operate the electronic device under the authority Authority_1 of the user account User_1.

It should be noted that if the administrator does not set the passwords Password_1, Password_2, Password_3 for the user accounts User_1, User_2, User_3, the processing module 14 will login and unlock the electronic device 1 by the user account User_1 corresponding to the slide path P1 after performing the slide gesture on the slide path P1.

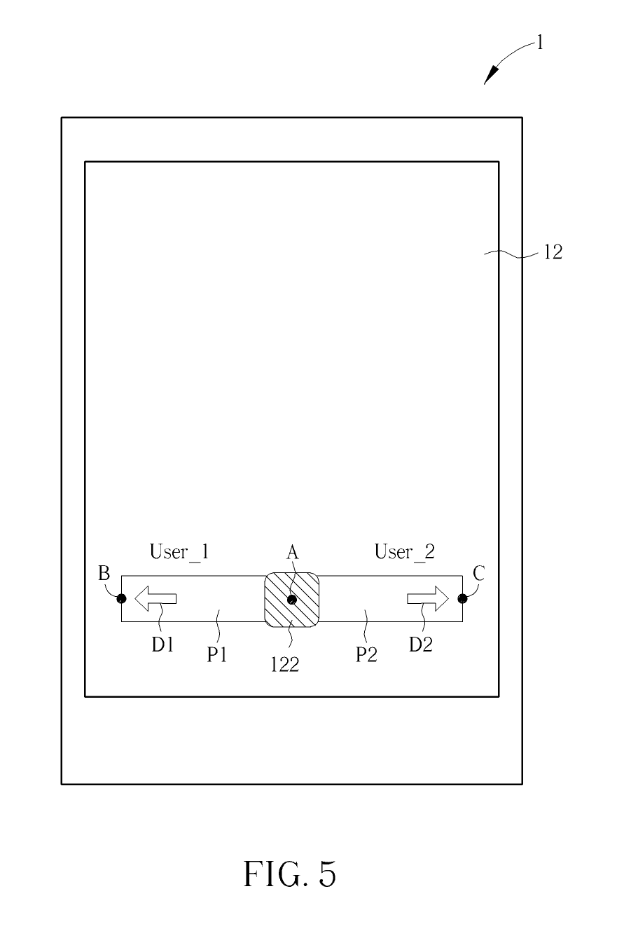

Referring to FIG. 5, FIG. 5 is a schematic diagram illustrating another login interface 120′ displayed in the touch display module 12 of the electronic device 1 shown in FIG. 1. The main difference between the login interface 120′ and the aforesaid login interface 120 is that the login interface 120′ comprises only two slide paths P1, P2 corresponding to two user accounts User_1, User_2. As shown in FIGS. 2 and 5, the invention can display different types of login interfaces in the touch display module 12 according to the number of user accounts.

It should be noted that the aforesaid login interfaces 120, 120′ may be further designed in different types according to different operating systems (e.g. iOS, Android, etc.) installed in the electronic device 1 except the number of user accounts.

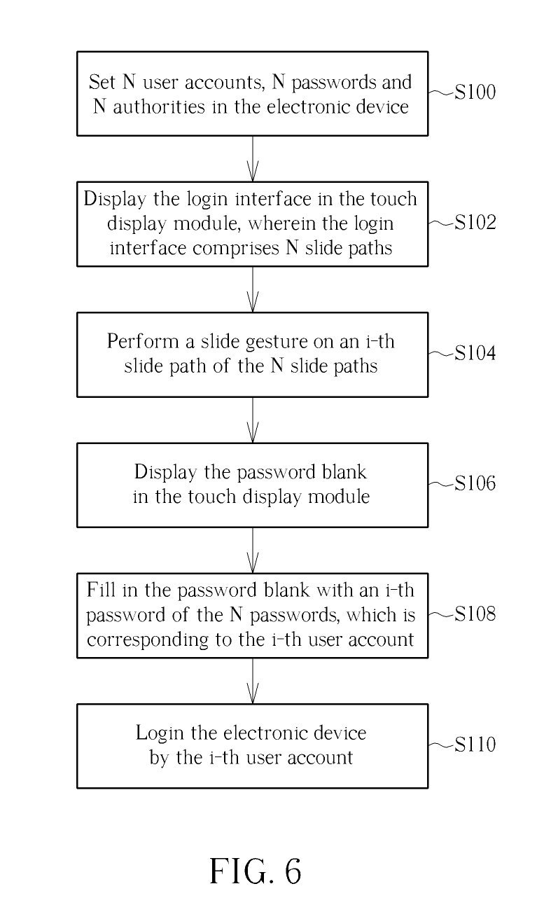

Referring to FIG. 6, FIG. 6 is a flowchart illustrating a login method for multiple users according to an embodiment of the invention. The login method shown in FIG. 6 can be applied to the electronic device 1 shown in FIG. 1. First of all, step S100 is performed to set N user accounts, N passwords and N authorities in the electronic device 1. Afterward, step S102 is performed to display the login interface 120 in the touch display module 12, wherein the login interface 120 comprises N slide paths. Step S104 is then performed to perform a slide gesture on an i-th slide path of the N slide paths. Step S106 is then performed to display the password blank 124 in the touch display module 12. Step S108 is then performed to fill in the password blank 124 with an i-th password of the N passwords, which is corresponding to the i-th user account. Finally, step S110 is performed to login the electronic device 1 by the i-th user account. It should be noted that the detailed operation and principle have been mentioned in the above and will not be depicted herein again.

Furthermore, the login interface 120 shown in FIG. 2, the login interface 120′ shown in FIG. 5 and the control logic of the login method for multiple users shown in FIG. 6 can be implemented by software. Each part or function of the control logic may be implemented by software, hardware or the combination thereof. Moreover, the control logic can be embodied by a computer readable storage medium, wherein the computer readable storage medium stores instructions, which can be executed by the electronic device 1 so as to generate control command for controlling the electronic device 1 to execute corresponding function.

As mentioned in the above, the invention allows an administrator to set a plurality of user accounts in the electronic device and displays a plurality of slide paths, which is corresponding to the plurality of user accounts, in the login interface. The administrator of the electronic device can set different authorities for the plurality of user accounts based on different usage requirements. After a user performs the slide gesture on one of the slide paths, he or she can login the electronic device by corresponding user account and can only use specific functions under the authority of the user account. Furthermore, the invention can further allow the administrator to set a plurality of passwords, which is corresponding to the plurality of user accounts, in the electronic device. After the user performs the slide gesture on one of the slide paths, he or she has to enter corresponding password so as to login the electronic device by corresponding user account. Accordingly, the invention can prevent the setting from being changed or prevent the data from being stolen by someone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device for multiple users comprising:
a storage module for storing N user accounts, N being a positive integer larger than one;
a touch display module; and
a processing module electrically connected to the storage module and the touch display module, the processing module being used for displaying a login interface in the touch display module, the login interface comprising N slide paths, each of the N slide paths being corresponding to one of the N user accounts;
wherein after performing a slide gesture on an i-th slide path of the N slide paths, the processing module logins the electronic device by an i-th user account of the N user accounts, which is corresponding to the i-th slide path, i is a positive integer smaller than or equal to N.

2. The electronic device for multiple users of claim 1, wherein the storage module further stores N passwords, each of the N passwords is corresponding to one of the N user accounts, after performing the slide gesture on the i-th slide path, the processing module displays a password blank, after filling in the password blank with an i-th password of the N passwords, which is corresponding to the i-th user account, the processing module logins the electronic device by the i-th user account.

3. The electronic device for multiple users of claim 2, wherein the storage module further stores N authorities and each of the N authorities is corresponding to one of the N user accounts.

4. The electronic device for multiple users of claim 1, wherein a start point and an end point are defined on each of the N slide paths and the slide gesture is performed to slide from the start point to the end point of the i-th slide path.

5. The electronic device for multiple users of claim 1, wherein the login interface further comprises a slide block for performing the slide gesture.

6. The electronic device for multiple users of claim 1, wherein the processing module displays the N user accounts on the N slide paths correspondingly.

7. The electronic device for multiple users of claim 1, wherein the processing module displays a slide direction on each of the N slide paths.

8. A login method for multiple users comprising:
setting N user accounts in an electronic device, wherein the electronic device comprises a touch display module and N is a positive integer larger than one;
displaying a login interface in the touch display module, wherein the login interface comprises N slide paths and each of the N slide paths is corresponding to one of the N user accounts; and
performing a slide gesture on an i-th slide path of the N slide paths so as to login the electronic device by an i-th user account of the N user accounts, which is corresponding to the i-th slide path, wherein i is a positive integer smaller than or equal to N.

9. The login method for multiple users of claim 8, further comprising:
setting N passwords in the electronic device, wherein each of the N passwords is corresponding to one of the N user accounts;
after performing the slide gesture on the i-th slide path, displaying a password blank in the touch display module; and
after filling in the password blank with an i-th password of the N passwords, which is corresponding to the i-th user account, logining the electronic device by the i-th user account.

10. The login method for multiple users of claim 9, further comprising:
setting N authorities in the electronic device, wherein each of the N authorities is corresponding to one of the N user accounts.

11. The login method for multiple users of claim 8, wherein a start point and an end point are defined on each of the N slide paths and the slide gesture is performed to slide from the start point to the end point of the i-th slide path.

12. The login method for multiple users of claim 8, wherein the login interface further comprises a slide block for performing the slide gesture.

13. The login method for multiple users of claim 8, further comprising:
displaying the N user accounts on the N slide paths correspondingly.

14. The login method for multiple users of claim 8, further comprising:
displaying a slide direction on each of the N slide paths.
